(19) United States
(12) Patent Application Publication
(10) Pub. No.: US 2014/0122119 A1
(43) Pub. Date: May 1, 2014

(54) MEDICAL DATA STORAGE AND RETRIEVAL

(71) Applicant: ECHOSTAR TECHNOLOGIES, LLC, Englewood, CO (US)

(72) Inventor: Christofer Hardy, Cheyenne, WY (US)

(73) Assignee: EchoStar Technologies, LLC, Englewood, CO (US)

(21) Appl. No.: 13/660,908

(22) Filed: Oct. 25, 2012

(51) Int. Cl. G06Q 50/24

(52) U.S. Cl. 705/3

(57) ABSTRACT

Systems and methods for medical data storage and retrieval are described. An exemplary method may include receiving identifying information from a patient at an electronic terminal over a first communications channel. The method may further include transmitting from the electronic terminal a request for recorded information specific to the patient, where the recorded information is stored externally to a facility containing the electronic terminal. The request may include the received identifying information and may be transmitted over a second communications channel. The method may still further include receiving the recorded information specific to the patient at the electronic terminal.

### TECHNICAL FIELD

The present technology relates to systems and methods for accessing and connecting databases. More specifically, the present technology relates to methods and systems for storing and retrieving patient specific information from disparate healthcare provider systems.

### BACKGROUND

As the number of specialists in the healthcare provider field increases, the produced data for individual patients can be spread across a greater number of databases and systems. When a patient visits a general practitioner, the general practitioner may not have access to all information, tests, and prescriptions relating to the patient. For example, if a patient visited a competitor practice, the healthcare provider may not have electronic access to the competitor records. The patient may also not be able to provide all of this information for several reasons that may include not having access to the information or not having a list of all prescription medications available at all times. These issues may increase costs for the healthcare provider who may not be able to realize revenue on the visit and may need to schedule follow-up visits. Additionally, these issues may increase costs and frustration for the patient who must still pay a copay for each visit, while needing to schedule follow-up visits to ensure complete care.

Thus, there is a need for improved methods and systems for interconnecting a variety of healthcare systems that may be in different physical locations, and belong to unrelated networks. These and other issues are resolved with the present technology.

### SUMMARY

Systems and methods for medical data storage and retrieval are described. An exemplary method may include receiving identifying information from a patient at an electronic terminal of a healthcare provider over a first communications channel. The method may further include transmitting from the electronic terminal a request for recorded information specific to the patient, where the recorded information is stored externally to a facility containing the electronic terminal. The request may include the received identifying information, and be transmitted over a second communications channel. The method may still further include receiving the recorded information specific to the patient at the electronic terminal.

The method may further include transmitting a signal from the electronic terminal requesting the identifying information from a patient's electronic device. In one example, the electronic device can comprise a patient's mobile phone. The first communications channel may be wireless, infra-red, Bluetooth, or near field communication. In one example, the identifying information may be stored in electronics embedded within an insurance card provided by a healthcare insurance company. The request for recorded information may be transmitted to a centralized system having a database, or may be transmitted to a centralized system providing access to a plurality of healthcare provider systems. Additional information may be transmitted from the electronic terminal to the centralized system with or subsequent to the request. This information may include additional information specific to a patient, additional information related to the healthcare provider making the request from the electronic terminal, or both. The received recorded information may be received from a plurality of healthcare provider systems, and may include hospital records, issued prescriptions, MRI data, X-ray data, outpatient records, or secondary healthcare provider records.

Exemplary methods may include transmitting from an electronic terminal a request to an electronic device requesting patient identifying information from the electronic device. The methods may include receiving at the electronic terminal the identifying information from the electronic device, and transmitting from the terminal a request for recorded information specific to the patient, where the request includes the received identifying information. The method may also include receiving at the electronic terminal the recorded information specific to the patient.

The methods may further include requesting at the terminal additional input prior to transmitting the request, and this additional information may include a password or a type of patient specific information. The recorded information received may again include hospital records, issued prescriptions, MRI data, X-ray data, outpatient records, or secondary healthcare provider records. The request may also be transmitted to a centralized system having one or more databases, or providing access to a plurality of healthcare provider systems or databases. The received recorded information may be received from a plurality of healthcare provider systems.

The technology may also include a computer-readable medium with sets of instructions thereon, which when executed by a processor cause the processor to receive identifying information from an electronic device. The processor may further transmit a request for recorded information specific to the patient, where the request includes the received patient identifying information. The processor may also receive the recorded information specific to the patient.

The processor may further be caused to transmit a request to an electronic device requesting patient identifying information from the electronic device. The processor may also be caused to request additional information prior to transmitting the request, and the additional information may include patient specific information. The request may be transmitted to a centralized system providing access to a plurality of healthcare provider systems.

Such technology may provide numerous benefits over conventional techniques. For example, a healthcare provider may not need a patient to bring specific information to each and every appointment in order to maintain or develop records. Additionally, a healthcare provider may be provided access to any and all patient specific information that has accumulated, whether this information has been accumulated by the healthcare provider or some other provider. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a block diagram of an embodiment of a medical data storage system having one or more networks to retrieve healthcare data according to embodiments of the disclosed technology.

FIG. 2 shows an exemplary system design for medical data storage and retrieval systems according to embodiments of the disclosed technology.

FIG. 3 shows a flow diagram of an exemplary method for retrieving patient specific information according to embodiments of the disclosed technology.

FIG. 4 shows a flow diagram of an exemplary method for retrieving patient specific information according to embodiments of the disclosed technology.

FIG. 5 shows a simplified computer system that may be utilized to perform one or more of the operations discussed.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

The present technology is directed to systems and methods for storing and retrieving healthcare information. The technology may allow a healthcare provider to access patient specific information regardless of whether it was initially received by the healthcare provider or a different healthcare provider. In so doing, improved healthcare services may be provided that save costs and time over conventional provided care. These and other benefits will be explained in detail below.

Although embodiments detailed herein are directed toward storing and retrieving healthcare information, the principles may be extended to other types of information and devices, such as monetary information, educational information, workplace information, etc., as may be appreciated by those of skill in the art. The technology discussed herein additionally can be extended to any of a variety of other electronic devices, such as, for example, computers, tablets, hand-held mobile devices, cell phones, e-readers, personal media players, and the like. A person of ordinary skill in the art will recognize various alterations, additions, omissions, and substitutions, all of which are encompassed by the technology disclosed herein.

An example describing some of the facets of the disclosed technology described herein may better inform the reader before setting out certain specific information of the embodiments. A patient may visit a general practitioner or other healthcare provider. The patient may relate to the healthcare provider that the patient may be prescribed certain medications, may have undergone certain procedures, or may be additionally seen by other healthcare providers. The patient, however, may not have all of the specifics of the information, and the visited practitioner may not either. Accordingly, in embodiments, the patient may tap a contactless device located at an electronic terminal at the healthcare provider facility. The healthcare provider may read information from the contactless patient device, which may be related to patient specific information such as identifying information. The patient or practitioner may optionally be prompted at the electronic terminal to enter additional information. The retrieved identifying information may be transmitted over one or more networks to one or more healthcare database facilities that may retrieve all recorded information related to the patient. This recorded information may then be transmitted back to the electronic terminal at the healthcare provider facility such that the practitioner may then have a complete record of information relating to the visiting patient.

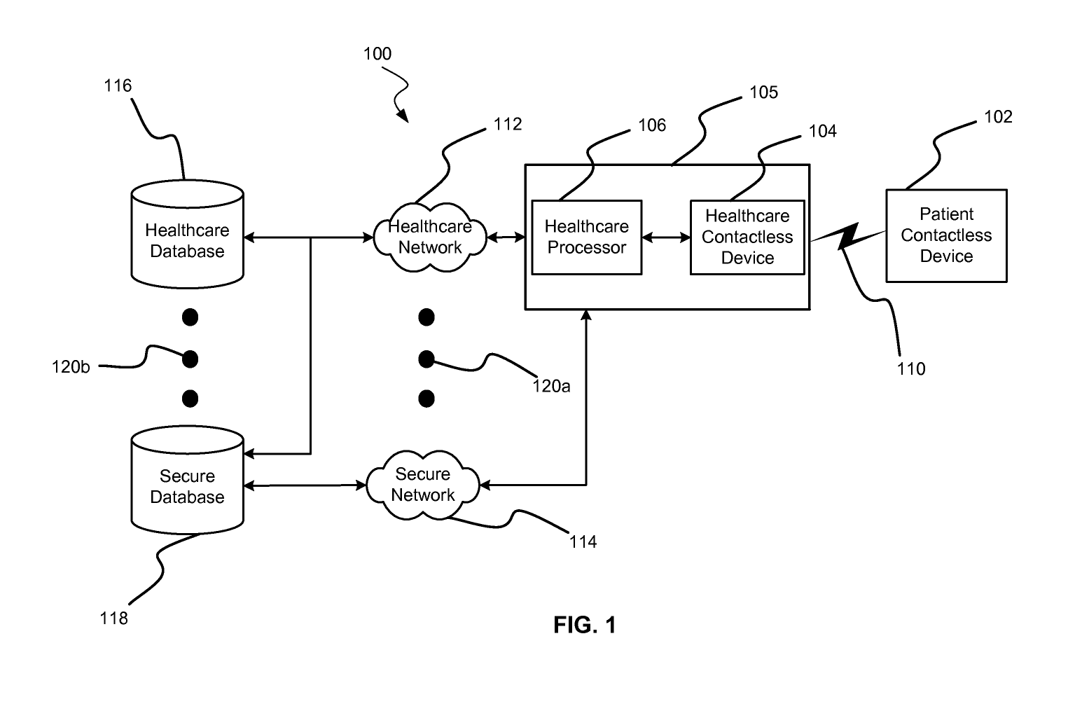

FIG. 1 shows a block diagram of an embodiment of a medical data storage system 100 having one or more networks to retrieve healthcare data according to embodiments of the disclosed technology. A patient contactless device 102 may be a device that allows for contactless, or minimal contact, transmission of patient specific information including identifying information. The patient contactless device 102 may allow a patient to provide specific information of the patient without the need to physically enter or verbally transmit the information. For example, the patient contactless device may be a mobile phone or an insurance card with electronics or a microchip embedded within. In disclosed embodiments, the patient contactless device 102 may be or include a near field communication (NFC) component for communicating with NFC sensors at an electronic terminal at the healthcare provider facility. The NFC component may be a radio frequency identification device (RFID) or other type device that can send and potentially receive information associated with a transaction.

First communications channel 110 may provide communications between the patient contactless device 102, and the healthcare contactless device 104. The healthcare contactless device 104 may be part of or communicatively coupled with an electronic terminal 105 at the healthcare provider facility. The first communications channel 110 may be any type of communications system including wireless, wired, or other communication system. In one embodiment, the first communications channel 110 is a wireless communication channel, and, in some embodiments, is an NFC channel. If a wireless communication channel, the first communication channel can be Bluetooth®, or other wireless systems. In embodiments, the communications channel is a radio frequency system that allows a patient to bring the patient contactless device 102 within close proximity of the healthcare contactless device 104 to establish communications. The brining the patient contactless device 102 into close proximity to the healthcare contactless device 104 may be referred to or relate to physically “tapping” the patient contactless device 102 with the healthcare contactless device or reader 104.

The healthcare contactless device 104 may be capable of reading or receiving information from the patient contactless device 102, and may be configured to deliver this received information to the electronic terminal 105 for use by the healthcare provider. The healthcare contactless device 104 may be configured both to receive communications from and send communications to the patient contactless device 102, depending on the technology associated with the patient contactless device 102. The healthcare contactless device 104 may be additionally configured to deliver communications to and receive communications from a healthcare processor 106. The healthcare contactless device 104 may communicate with the healthcare processor 106 over a communications channel. The channel may be wired or wireless depending on attributes of the electronic terminal 105. The channel may be or include wired media, for example, a LAN, WAN, the Internet, etc., to deliver the communications between the components.

The healthcare processor 106 may communicate with or be associated with one, two, or more networks or second communications channels. These networks may include, for example, one or more healthcare networks 112 and one or more secure networks 114 for sending and receiving patient specific information. The healthcare processor 106 may communicate patient identifying information, and request and receive patient specific recorded information over any one or more of networks 112, 114. As indicated by ellipses 120a-b, any number of networks and databases may be included in the system.

In an example, the patient arrives and is placed in an examination room or other private area at a healthcare provider facility. The examination room may contain electronic terminal 105. A healthcare practitioner may arrive to begin an examination or other procedure, and the patient may relate that the patient recently had an additional procedure performed, such as an MRI. The additional procedure may have been performed at a facility external to or unrelated to the facility at which the healthcare provider is located. In disclosed embodiments, the patient may be instructed by the healthcare provider to “tap” or otherwise communicate with the electronic terminal such that the MRI scan may be retrieved. The patient may run an application on the patient's mobile device, or produce an insurance card or other card with embedded electronics, 102 that includes specific patient identifying information. The patient may then “tap” or otherwise communicate this information from the patient's device 102 to the healthcare contactless device 104 associated with the electronic terminal 105.

The healthcare contactless device 104 may receive the patient identifying information. In disclosed embodiments, this information is transmitted to the healthcare processor 106, which may alter, encrypt, or add to the information, to produce a request. Additionally, the healthcare practitioner or the patient may provide additional information relating to the healthcare provider, the patient, the MRI procedure, or facility at which the procedure occurred. The healthcare processor 106 may then transmit the request for information, in this exemplary case the MRI scan, across one of the networks. For example, had the MRI been performed by the healthcare provider, or at one of its related facilities, healthcare network 112 may be used to access healthcare database 116, which may be a general storage database for all of the healthcare provider's facilities, or may be the database for a specific facility, such as the MRI scanning facility. Alternatively, if the healthcare provider is not associated with the facility at which the MRI procedure was performed, an alternative network, such as secure network 114 may be employed to retrieve the scan from secure database 118. Although not shown, it is to be understood that various additional components such as processors, servers, or institutional components, may be involved for receiving the request, accessing the database, retrieving information, etc.

Once the database at which the MRI scan is stored has been accessed, the patient identifying information included in the request may be utilized to retrieve the specific scan of the patient. Once the scan or data has been retrieved, it may be transmitted back across the healthcare network 112 or secure network 114 to the electronic terminal 105 of the healthcare provider. The practitioner and patient may then review the scan during the appointment, and delays related to retrieving the information by more conventional means, such as by mail, may be avoided.

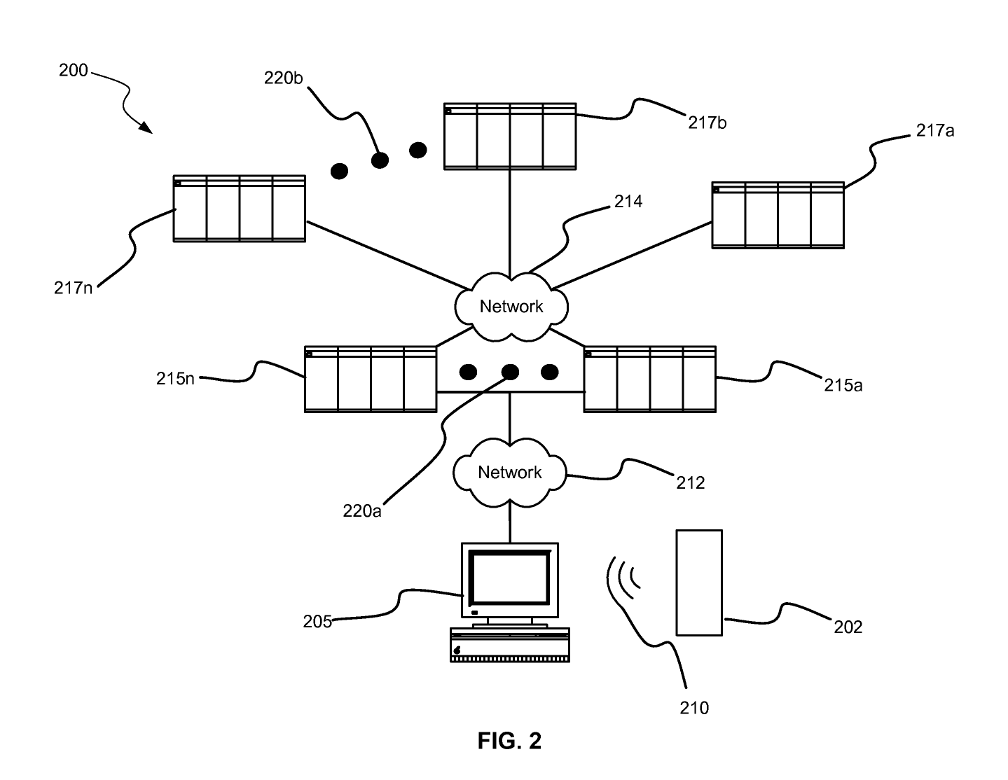

FIG. 2 shows an exemplary system design 200 for medical data storage and retrieval systems according to embodiments of the disclosed technology. The system 200 may include one or more insurance company networks, servers, etc., that may be utilized for the delivery, interconnection, and security of multiple healthcare provider systems. As previously described, the system may be utilized in a healthcare setting, in which a patient visits a healthcare provider such as a general practitioner, for example. The patient may possess patient electronic device 202 that may communicate with healthcare electronic terminal 205 over communications channel 210 as previously discussed. The communications channel 210 may provide bi-directional communication between the healthcare electronic terminal 205 and the patient electronic device 202. The patient electronic device 202 may communicate patient identifying information over communications channel 210 that is received by healthcare electronic terminal 205. In disclosed embodiments, the healthcare electronic terminal 205 may first prompt or request patient electronic device 202 for the patient identifying information.

Once received, healthcare electronic terminal 205 may utilize the patient identifying information to produce a request that may be transmitted over network 212. The request may include the patient identifying information, and may include additional information as well, including passcodes or passwords, electronic or digital signatures, electronic tokens, additional patient identifying information, network identifying information, or healthcare provider information for either the transmitting healthcare provider, or the healthcare provider possessing the patient specific information being requested. For example, network 212 may be a healthcare provider internal or external network such as previously described. The network 212 may additionally be a secure or other network providing access between the healthcare provider electronic terminal 205 and a healthcare insurance company 215. For example, the healthcare provider may be operable to communicatively connect to one or more healthcare insurance company systems 215a-n, that may include all available insurance companies. Alternatively, the system may include specific third-party brokers 215 that manage the transmission and performance of information requests. As the healthcare provider may consult patients associated with a variety of healthcare insurance companies, the healthcare provider may be provided access to these healthcare insurance companies systems when, for example, contractual obligations are enacted. For example, when a healthcare provider contracts with a healthcare insurance company for rates, fees, etc., the healthcare provider may be provided access to all other healthcare providers associated with the healthcare insurance company. Because many patients visit multiple healthcare providers that are “in-network” or deemed acceptable by the healthcare insurance company to which the patient belongs, the healthcare insurance company may be capable of creating an interconnected network between all of the providers in the network.

The patient identifying information provided may include the specific healthcare insurance company with which the patient is associated, and the request may be delivered over a network 212 associated with that healthcare insurance company. The healthcare insurance company system 215 may receive the request over network 212, and may process the request. The healthcare insurance company system 215 may request additional information from the healthcare provider or patient that may then be provided prior to the healthcare insurance company performing the transmitted request. The healthcare insurance company system 215 may then perform the request by accessing an additional healthcare provider system 217 on which the requested patient specific information is located. The healthcare insurance company system 215 may reformat the request, add information to the request, or directly transmit the request over network 214 to the healthcare provider 217. Network 214 may be a similar or different network from network 212, and may be a private network accessible only to healthcare providers associated with the specific healthcare insurance company 215. Also, as represented by ellipses 220a-b, there may be any number of insurance companies 215 or healthcare providers 217 included in the system described.

The healthcare insurance company system 215 may review the transmitted request to determine what patient is associated with the request, what healthcare provider 217 is associated with the request, or what patient specific recorded information is being requested. As discussed previously, if the request is faulty, or if additional information including a security check is required, the healthcare insurance company system 215 may request such information prior to performing the request. Utilizing the information included in the request, the healthcare insurance company system 215 may access either an internal database of the healthcare insurance company (not shown), or transmit the request to the specific healthcare provider 217 possessing the requested information. Such a system may beneficially provide access between competing healthcare providers, while maintaining security between the providers. For example, because patient specific information possessed only by the patient is required to perform a request, competing healthcare providers may be prevented from otherwise accessing competitor systems inappropriately. Additionally, because the healthcare insurance company 215 may be the first point of contact between any two healthcare providers, additional securities may be enacted by the healthcare insurance company to restrict unauthorized access between competitor databases.

Unlike other systems, healthcare information systems may be unique in the lack of access of a patient to that patient's own records. For example, as compared to financial systems, a consumer may likely possess account information and passwords to access all of a consumer's financial information at various institutions. Accordingly, systems may be developed that allow a consumer to access all different financial institutions from a single point based on the consumer's personal account information. In healthcare, however, a patient may likely not have access to the personal records stored with a specific healthcare provider or with any healthcare provider with which the patient has been associated. The present technology allows for a system that maintains the integrity of privacy and delivery of patient information, but allows improved access to this information through a brokered network maintained, for example, by the specific insurance companies.

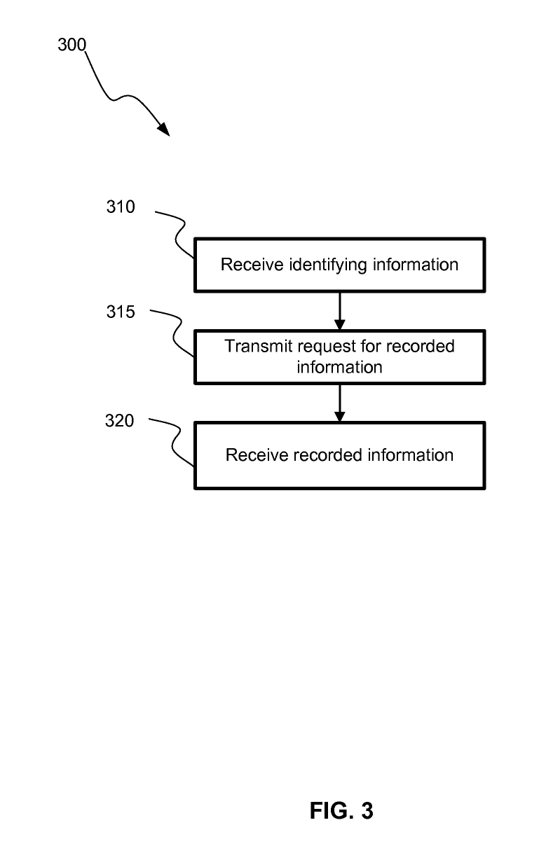

FIG. 3 shows a flow diagram of an exemplary method 300 for retrieving patient specific information according to embodiments of the disclosed technology. The method may include receiving identifying information from a patient at an electronic terminal of a healthcare provider over a first communications channel at step 310. The identifying information may include a variety of information including name, address, date of birth, social security number, insurance company and insurance company ID, a personalized electronic token, etc., or any other information that may personally identify the patient. The electronic terminal may transmit a request over a second communications channel for recorded information specific to the patient at step 315. The recorded information may be stored externally to a facility containing the electronic terminal, and may or may not be possessed by a facility related to the healthcare provider or a competitor. The request may include some or all of the identifying information received from the patient. In response to the request, the electronic terminal may receive the requested recorded information specific to the patient at step 320.

The identifying information may be received directly from a patient, and may be received from one or more patient devices. Although the information may be input directly at the electronic terminal by a patient or practitioner, the information may also be received from an electronic device of the patient. For example, the patient may possess the information on a mobile phone that can be used to transmit the information from the patient mobile phone to the electronic terminal of the healthcare provider. The mobile phone may include an application, or other defined storage area that includes the information. For example, the patient may have previously downloaded an application from the patient's healthcare insurance company, and then set-up the identifying information through the application. At the healthcare provider, the patient may open or run the application which may automatically deliver the identifying information to the healthcare provider electronic terminal.

For example, the healthcare provider electronic terminal may include similar or additional software provided by the insurance company such that when the patient runs the application, a secure connection may be developed between the patient device and the electronic terminal for transmitting the patient specific information. The healthcare electronic terminal may also prompt the patient electronic device requesting the identifying information from the device. For example, either automatically or through an action by the practitioner or patient, the electronic terminal may transmit a request or instruction to the patient electronic device. This action may directly retrieve the information from the patient electronic device without further interaction by the patient or practitioner, open the previously described application, or prompt the patient on the device. An alert may be presented on the device informing the patient the information has been requested. The alert may also prompt the user to allow the identifying information to be sent, and the user may need to accept or perform some other task to allow the information to be transmitted. Such a system allows the patient to maintain control over when and perhaps what identifying information is transmitted.

The information may be transmitted wirelessly, and for example the first communications channel may be near field communication. In disclosed embodiments, when the patient is accepted by a specific healthcare insurance company, the company may provide the patient with an insurance card. The insurance card may have electronics embedded within the card, such as a microchip, that maintains all of the needed identifying information for each specific patient. The data may be encrypted such that it may only be accessed and decrypted by an application that may be provided to the healthcare provider companies. The patient may also be provided or may set up a password that is utilized to provide access to the information on the card. When the patient visits a healthcare provider, the patient may “tap” the card on a contactless reader communicatively coupled with the electronic terminal to deliver this information. The electronic terminal may or may not then present a prompt in which the patient may type his or her personal passcode or provide a digital signature of some type. The prompt may appear on either or both of the patient's electronic device, or the electronic terminal at the healthcare provider facility. For example, the electronic terminal may include a signature pad for providing an electronic signature, or the patient's electronic device may include such functionality.

The electronic terminal may perform certain tasks with the received identifying information prior to transmitting the request. For example, the electronic terminal may encrypt the information, or include additional information to create the request. The practitioner may have identified the specific information or data needed, or the healthcare provider from whom the information is needed, and this information may be included in the request. Additional patient information or information identifying the healthcare provider may also be included. The request may be transmitted directly to the healthcare provider possessing the information, or may be transmitted to a centralized system providing access to one or more of a plurality of healthcare provider systems.

When transmitted to a centralized system providing access to additional healthcare provider systems, in response to receiving the request, the centralized system may request additional information before proceeding. For example, the system may request information that may be provided directly by the electronic terminal identifying the healthcare provider or specific patient, or alternatively, the request from the centralized system may be directed to the patient or practitioner. For example, the centralized system may be operated by the healthcare insurance company or a third-party broker, and this entity may require a patient specific passcode or password or additional patient specific information in order to provide continued access. The patient may enter the password providing additional security to the transaction on the patient electronic device or the healthcare provider electronic terminal. In disclosed embodiments the practitioner may be required to enter identifying information for the practitioner or the healthcare provider. This information may be a personal identification code assigned to the practitioner, or a general code or information related to or associated with the healthcare provider. Entering this information may allow access to the centralized system such that the request may proceed. Requiring additional identifying information of the practitioner may provide improved security over the system such that all requests may be identified and the requesting practitioner may be monitored to ensure compliance with security measures and confidentiality between healthcare providers. All or any of this additional information may be provided at the electronic terminal to gain access to the centralized system and proceed with the request.

The request may then be provided to the healthcare provider or provider system possessing the information and then retrieved from the associated database. The practitioner may request information specific to the patient from a plurality of healthcare providers. For example, when a patient begins care with a new general practitioner, the practitioner may request all information associated with the patient from all previous healthcare providers who have performed services for the patient. This may be transmitted as a single or series of requests that are parsed to the specific healthcare providers by the electronic terminal. For example, the requests may identify what information is required from each healthcare provider, and thus the electronic terminal may appropriately deliver the information. The patient may not be aware of all information available, but may know the names, addresses, or other identifying information of the previous healthcare providers that the patient visited. The practitioner may present this information to the electronic terminal that can then request any and all information from each healthcare provider.

If the system is designed to provide access via a centralized system, the specific healthcare provider information may not be necessary. For example, a general request for all information may be provided to the centralized system that may then access internal data to determine each healthcare provider from whom information is needed. The centralized system may then provide individual requests to each of the healthcare providers, and recorded information may then be received from a plurality of healthcare provider systems.

One centralized system may be utilized by multiple healthcare insurance companies, or individual insurance companies may utilize their own network. In the situation where a patient may have changed insurance companies, such as by changing jobs where the next job utilizes a different healthcare insurance provider, the healthcare insurance systems may be configured to communicate with one another as well. For example, the request may be transmitted to the centralized system associated with the present insurance company utilized by the patient. That centralized system may identify that a previous healthcare insurance company was associated with the patient, and may forward the request to that network for retrieval of information through that related system, which may involve different or other healthcare providers. In this way, healthcare providers associated with different networks may be connected to any number of networks for providing healthcare information associated with specific patients. A variety of other situations related to the disclosed systems are envisioned and encompassed by the present technology as well.

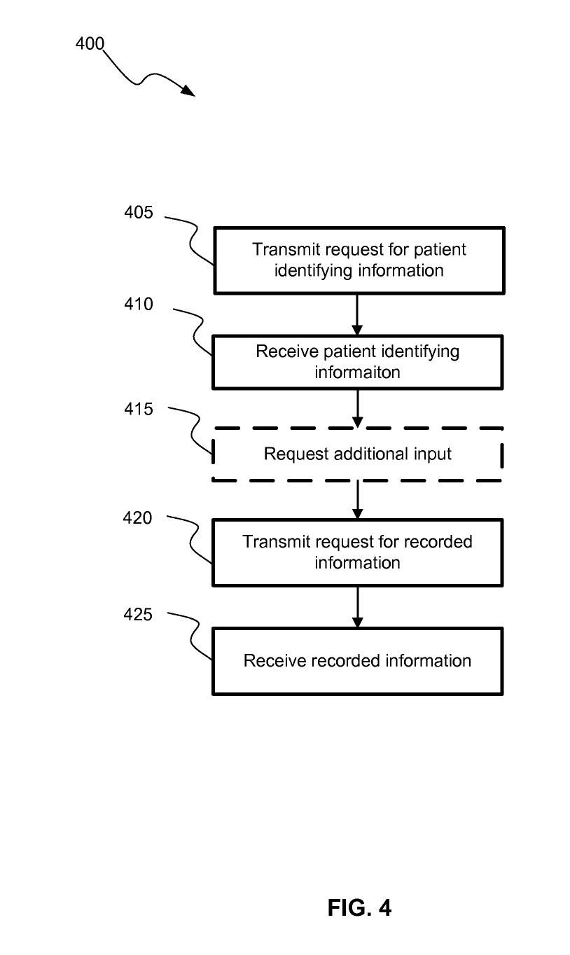

FIG. 4 shows a flow diagram of an exemplary method 400 for retrieving patient specific information according to embodiments of the disclosed technology. The method may include transmitting a request from an electronic terminal to an electronic device at step 405. The transmission may specify the information being requested, and the information may include specific patient identifying information as previously described. The electronic terminal may receive the patient identifying information at step 410. The patient identifying information may be received from the electronic device, which may be a mobile phone, key fob, or other electronic device possessed by the patient. The method may optionally include requesting additional input at step 415 that may include information from the patient or practitioner.

Once all required patient identifying information has been received, at step 420 the electronic terminal may transmit a request for recorded information specific to the patient. The request may include the received identifying information and may include the optionally received additional information as well. In response to the request, at step 425 the requested recorded information specific to the patient may be received at the electronic terminal.

The additional information that may optionally be requested may be requested in a similar or different fashion than the original patient identifying information. For example, if a mobile phone application is being utilized, a second request may be transmitted securely between the electronic terminal and mobile phone requesting the patient to provide verification or some additional information. The electronic terminal may receive the initial information and produce a challenge related to the received identifying information. For example, the patient identifying information may include a date of birth for the patient. Because the information was stored in the application, the holder of the mobile phone may not necessarily possess this date of birth information if they are not the true owner of the phone such as a different family member, for example. Accordingly, the electronic terminal may formulate a challenge with information provided in the received identifying information, and one exemplary challenge may be a request to verify the patient's date of birth. If answered correctly, the request may proceed, but if answered incorrectly, the electronic terminal may issue a warning that the answer was incorrect. An additional challenge may be offered, or an additional opportunity may be granted to correctly answer the challenge. If a correct answer cannot be provided, the electronic terminal may alert the practitioner to ensure identity theft has not occurred. Under disclosed embodiments, the practitioner may be able to override the challenge system, such as if the practitioner personally knows the patient and can verify the identity. The challenge or request for additional information may also not be contained in the originally transmitted identifying information such as in the case of a required passcode or password. The password may have been issued by an insurance company, or determined by the patient when the mobile phone application was prepared for the patient. The additional information may also be any other patient specific information. This patient specific information may include age, personal status information including marital status, date of birth, social security number, sibling, parent, spouse, or other familial identifying information, etc.

The recorded information that may be received from a single or a plurality of healthcare provider systems, may include any recorded information that may include hospital records, performed procedure information, presently prescribed medications, previously prescribed medications, inpatient records, outpatient records, laboratory information such as blood work, emergency room medical records, X-ray scans or data, MRI scans or data, etc. The information may also include secondary healthcare provider information, such as information related to treatment at a physical therapy facility, rehabilitation facility including drug, alcohol, or disorder rehabilitation, as well as alternative medical facilities such as, for example, a chiropractic facility or acupuncture facility.

The request may be transmitted to a database associated with the healthcare provider, one or more different healthcare providers or secondary healthcare providers, or one or more centralized systems. If a centralized system is utilized, additional information may be requested by this system for security or other purposes, such as if the initial request is faulty or does not include all required information. For example, a presented challenge may be specifically associated with the centralized system, which may be the healthcare insurance company. The originally transmitted patient identifying information may include a challenge question that is recognized by the electronic terminal for presentation to the patient. This challenge question may be transmitted back to the patient electronic device for answer. The challenge question may have been previously set up when the patient set up an account with the healthcare insurance company, for example, along with an answer for the challenge question. The patient may enter an answer to the challenge, which is included with the request for additional information. The centralized system may then review the request and compare it to internal records to determine whether the correct answer to the predetermined challenge question has been provided. If so, the request may proceed to the specific healthcare providers. If not, a response may be provided back to the electronic terminal that the challenge has failed, and a request for additional information, such as a new answer to the challenge may be requested. The response also may be transmitted directly to the patient or a patient mobile device alerting the patient that an unauthorized request may be occurring. The patient may then respond directly to the alert, or provide a second answer to the prompt from the centralized system. A backup challenge may also be presented by the centralized system directly to the patient to ensure security and privacy of patient information is maintained.

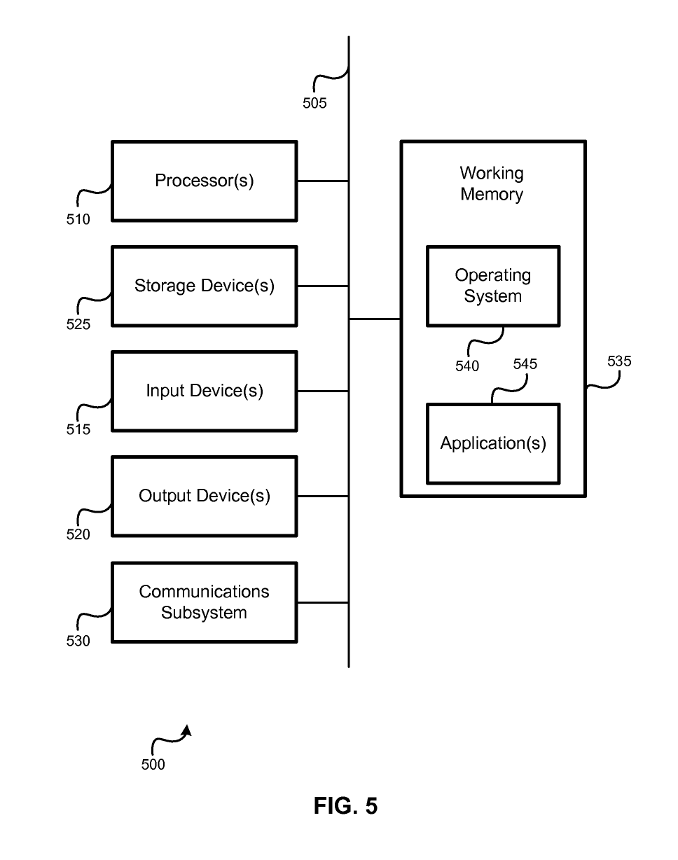

FIG. 5 illustrates an embodiment of a computer system 500. A computer system 500 as illustrated in FIG. 5 may be incorporated into devices such as a healthcare electronic terminal, a patient electronic device, a centralized system, and the like. Moreover, some or all of the components of the computer system 500 may also be incorporated into a portable electronic device, mobile phone, or other device as described herein. FIG. 5 provides a schematic illustration of one embodiment of a computer system 500 that can perform the methods provided by various embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, and/or the like); one or more input devices 515, which can include without limitation a mouse, a keyboard, a camera, and/or the like; and one or more output devices 520, which can include without limitation a display device, a printer, and/or the like. The input devices may also include a contactless reader or output as previously described directly coupled or remotely coupled with the computer system 500 such as coupled with the healthcare electronic terminal.

The computer system 500 may further include (and/or be in communication with) one or more non-transitory storage devices 525, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device, and/or a chipset (such as a Bluetooth™ device, an 802.11 device, a WiFi device, a WiMax device, cellular communication facilities, etc.), and/or the like. The communications subsystem 530 may include one or more input and/or output communication interfaces to permit data to be exchanged with a network (such as the network described below, to name one example), other computer systems, television, and/or any other devices described herein. Depending on the desired functionality and/or other implementation concerns, a portable electronic device (or similar device) may communicate image and/or other information via the communications subsystem 530. In other embodiments, a portable electronic device, e.g. the healthcare contactless device, may be incorporated into the computer system 500, e.g., healthcare electronic terminal, as an input device 515. In many embodiments, the computer system 500 will further comprise a working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above, such as those described in relation to FIGS. 3 and 4, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 525 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 500) to perform methods in accordance with various embodiments of the technology. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 525. Volatile media include, without limitation, dynamic memory, such as the working memory 535.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 530 (and/or components thereof) generally will receive signals, and the bus 505 then might carry the signals (and/or the data, instructions, etc. carried by the signals) to the working memory 535, from which the processor(s) 510 retrieves and executes the instructions. The instructions received by the working memory 535 may optionally be stored on a non-transitory storage device 525 either before or after execution by the processor(s) 510.

The methods, systems, and devices discussed above are examples, and are not intended to limit the scope, applicability, or configuration of the possible embodiments. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bound the scope of the claims.

Where a range of values is provided, it is understood that each intervening value, to the smallest fraction of the unit of the lower limit, unless the context clearly dictates otherwise, between the upper and lower limits of that range is also specifically disclosed. Each smaller range between any stated value or intervening value in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a healthcare provider” includes a plurality of such providers, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A method of retrieving patient specific information, the method comprising:
receiving, at an electronic terminal of a healthcare provider, identifying information, regarding a patient, from an electronic device of the patient, over a first communications channel;
transmitting from the terminal a request for recorded information specific to the patient over a second communications channel, wherein the recorded information is stored externally to a facility containing the electronic terminal, and the request comprises the received identifying information; and
receiving at the electronic terminal the recorded information specific to the patient.

2. The method of retrieving patient specific information of claim 1, further comprising:
receiving other recorded information, specific to the patient, over the first communication channel, in association with the identifying information; and
generating the request based on the other record information.

3. The method of retrieving patient specific information of claim 2, further comprising:
outputting the other recorded information, from the electronic terminal, for presentation to a health care professional;
receiving user input from the health care professional; and
utilizing the user input to generate the request.

4. The method of retrieving patient specific information of claim 3, wherein the other recorded information identifies a plurality of visits to medical offices by the patient, and wherein the user input identifies a particular healthcare provider system associated with one at least one of the plurality of visits of medical offices.

5. The method of retrieving patient specific information of claim 2, wherein the electronic device comprises a mobile phone.

6. The method of retrieving patient specific information of claim 1, wherein the first communications channel comprises near field communication.

7. The method of retrieving patient specific information of claim 6, wherein the identifying information is received from an electronics-embedded insurance card.

8. The method of retrieving patient specific information of claim 1, wherein the request is transmitted to a centralized system providing access to a plurality of healthcare provider systems.

9. The method of retrieving patient specific information of claim 1, wherein the recorded information is received from a plurality of healthcare provider systems.

10. The method of retrieving patient specific information of claim 1, wherein the recorded information is selected from the group consisting of a hospital record, an issued prescription, an MRI scan, and X-ray, an outpatient record, and a secondary healthcare provider record.

11. A method of retrieving patient specific information, the method comprising:
transmitting, from an electronic terminal, a request to an electronic device requesting patient identifying information from the electronic device;
receiving at the electronic terminal the identifying information from the electronic device;
transmitting from the terminal a request for recorded information specific to the patient, wherein the request comprises the received identifying information; and
receiving at the electronic terminal the recorded information specific to the patient.

12. The method of retrieving patient specific information of claim 11, further comprising requesting at the terminal additional input prior to transmitting the request.

13. The method of retrieving patient specific information of claim 12, wherein the additional input comprises a password.

14. The method of retrieving patient specific information of claim 12, wherein the additional input comprises a type of patient specific information.

15. The method of retrieving patient specific information of claim 11, wherein the recorded information is selected from the group consisting of a hospital record, an issued prescription, an MRI scan, and X-ray, an outpatient record, and a secondary healthcare provider record.

16. The method of retrieving patient specific information of claim 11, wherein the request is transmitted to a centralized system providing access to a plurality of healthcare provider systems.

17. The method of retrieving patient specific information of claim 11, wherein the recorded information is received from a plurality of healthcare provider systems.

18. A computer readable medium with sets of instructions thereon, which when executed by a processor cause the processor to:
receive identifying information from an electronic device;
transmit a request for recorded information specific to the patient, wherein the request comprises the received identifying information; and
receive the recorded information specific to the patient.

19. The computer readable medium of claim 18, further comprising additional instructions, which when executed by the processor further cause the processor to:
transmit a request to an electronic device requesting patient identifying information from the electronic device.

20. The computer readable medium of claim 18, further comprising additional instructions, which when executed by the processor further cause the processor to:
request additional information prior to transmitting the request.
